(19) United States
(12) Patent Application Publication
(10) Pub. No.: US 2026/0231199 A1
(43) Pub. Date: Aug. 6, 2026

(54) SELECTION AND RESELECTION OF RESOURCES FOR TRANSMISSION

(71) Applicant: QUALCOMM Incorporated, San Diego, CA (US)

(72) Inventors: Giovanni CHISCI, San Diego, CA (US); Chih-Hao LIU, San Diego, CA (US); Stelios STEFANATOS, San Diego, CA (US); Jing SUN, San Diego, CA (US); Xiaoxia ZHANG, San Diego, CA (US); Qing LI, Princeton Junction, NJ (US)

(21) Appl. No.: 19/147,564

(22) PCT Filed: Nov. 29, 2023
(86) PCT No.: PCT/US2023/081593

§ 371 Date: Jul. 11, 2025

(30) Foreign Application Priority Data
Feb. 17, 2023 (GR) 20230100132

(51) Int. Cl. H04W 72/50

(52) U.S. Cl. CPC H04W 72/535

(57) ABSTRACT

Various aspects of the present disclosure generally relate to wireless communication. Various aspects relate generally to a configuration for reselection of resources for transmission of one or more transport blocks (TBs) for a sidelink communication. Some aspects more specifically relate to providing a configuration that indicates whether to reselect resources for resources to transmit the one or more TBs in association with an unavailability of one or more resources of a first set of resources selected for transmission of the one or more TBs. In some aspects, the configuration may indicate whether to transmit the one or more TBs via available resources of the first set of resources (for example, remaining resources that are not first set of resources unavailable) or to reselect a second set of resources for transmission of the one or more TBs.

### CROSS-REFERENCE TO RELATED APPLICATION

This Patent Application claims priority to Greece Patent Application No. 20230100132, filed on Feb. 17, 2023, entitled “SELECTION AND RESELECTION OF RESOURCES FOR TRANSMISSION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically, to techniques and apparatuses for selection and reselection of resources for transmission.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

In some networks, a wireless communication device (WCD) may select a resource, in a sidelink channel, for transmission of a transport block (TB). The WCD may evaluate availability of the resource after selection of the resource and before transmission of the TB via the resource. If the WCD determines that the resource is unavailable, the WCD may reselect a new resource for transmission of the TB.

In some networks, the WCD may select a set of resources, in the sidelink channel, for transmission of one or more TBs. The set of resources may have a quantity of resources that is more than a quantity that is needed to transmit the one or more TBs. However, the WCD typically reselects a new set of resources based on a determination of unavailability of any resource of the set of resources.

### SUMMARY

Some aspects described herein relate to a method of wireless communication performed by a wireless communication device (WCD). The method may include performing, after selection of a first set of resources for a transmission of one or more transport blocks (TBs), one or more evaluations of availability of the first set of resources. The method may include performing, in association with an unavailability of one or more resources of the first set of resources, one of: transmission of the one or more TBs via one or more available slots of the first set of resources reselection of a second set of resources for transmission of the one or more TBs and transmission of the one or more TBs via the second set of resources, or reselection of a third set of resources for transmission of a first subset of the one or more TBs and transmission of a second subset of the one or more TBs on a subset of the first set of resources.

Some aspects described herein relate to a WCD for wireless communication. The wireless communication device may include a processing system that includes one or more processors and one or more memories coupled with the one or more processors. The processing system may be configured to cause the WCD to perform, after selection of a first set of resources for a transmission of one or more TBs, one or more evaluations of availability of the first set of resources. The processing system may be configured to cause the WCD to perform, in association with an unavailability of one or more resources of the first set of resources, one of: transmission of the one or more TBs via one or more available slots of the first set of resources; reselection of a second set of resources for transmission of the one or more TBs and transmission of the one or more TBs via the second set of resources; or reselection of a third set of resources for transmission of a first subset of the one or more TBs and transmission of a second subset of the one or more TBs on a subset of the first set of resources.

Some aspects described herein relate to a non-transitory computer-readable medium that stores a set of instructions for wireless communication by a WCD. The set of instructions, when executed by one or more processors of the WCD, may cause the WCD to perform, after selection of a first set of resources for a transmission of one or more TBs, one or more evaluations of availability of the first set of resources. The set of instructions, when executed by one or more processors of the WCD, may cause the WCD to perform, in association with an unavailability of one or more resources of the first set of resources, one of: transmission of the one or more TBs via one or more available slots of the first set of resources; reselection of a second set of resources for transmission of the one or more TBs and transmission of the one or more TBs via the second set of resources; or reselection of a third set of resources for transmission of a first subset of the one or more TBs and transmission of a second subset of the one or more TBs on a subset of the first set of resources.

Some aspects described herein relate to an apparatus for wireless communication. The apparatus may include means for performing, after selection of a first set of resources for a transmission of one or more TBs, one or more evaluations of availability of the first set of resources. The apparatus may include means for performing, in association with an unavailability of one or more resources of the first set of resources, one of: transmission of the one or more TBs via one or more available slots of the first set of resources reselection of a second set of resources for transmission of the one or more TBs and transmission of the one or more TBs via the second set of resources, or reselection of a third set of resources for transmission of a first subset of the one or more TBs and transmission of a second subset of the one or more TBs on a subset of the first set of resources.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example network node in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram of an example associated with selection of resources for transmission of a transport block (TB) via a sidelink channel, in accordance with the present disclosure.

FIG. 6 is a diagram of an example associated with selection of resources for transmission of a TB via a sidelink channel, in accordance with the present disclosure.

FIG. 7 is a diagram of an example associated with selection and reselection of resources for transmission, in accordance with the present disclosure.

FIG. 8 is a diagram of an example associated with selection and reselection of resources for transmission, in accordance with the present disclosure.

FIG. 9 is a diagram illustrating an example process performed, for example, by a wireless communication device, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to a configuration for reselection of resources for transmission of one or more transport blocks (TBs) for a sidelink communication. Some aspects more specifically relate to providing a configuration that indicates whether to reselect resources to transmit the one or more TBs in association with an unavailability of one or more resources of a first set of resources selected for transmission of the one or more TBs. In some aspects, the configuration may indicate whether to transmit the one or more TBs via available resources of the first set of resources (for example, remaining resources that are not unavailable) or to reselect a second set of resources for transmission of the one or more TBs.

In some aspects, a wireless communication device (WCD) may reselect the second set of resources based at least in part on the available resources being insufficient for transmitting the one or more TBs, a threshold percentage of the first set of resources being unavailable, or a quantity of contiguous slots failing to satisfy a threshold quantity, among other examples. In some examples, the WCD may reselect the second set of resources to replace all of the first set of resources. In some other examples, the WCD may transmit a first subset of the one or more TBs via the available resources of the first set of resources and a second subset of the one or more TBs via the second set of resources.

Particular aspects of the subject matter described in this disclosure can be implemented to realize one or more of the following potential advantages. In some examples, the described techniques can be used to use, when efficient, available resources of a set of resources to transmit all or a subset of TBs. In this way, a WCD may use the available resources, rather than wasting the available resources and reselecting a new, full set of resources. This may improve spectral efficiency and improve latency in an associated network by conserving network resources that may have otherwise been wasted or selected to be in the new, full set of resources.

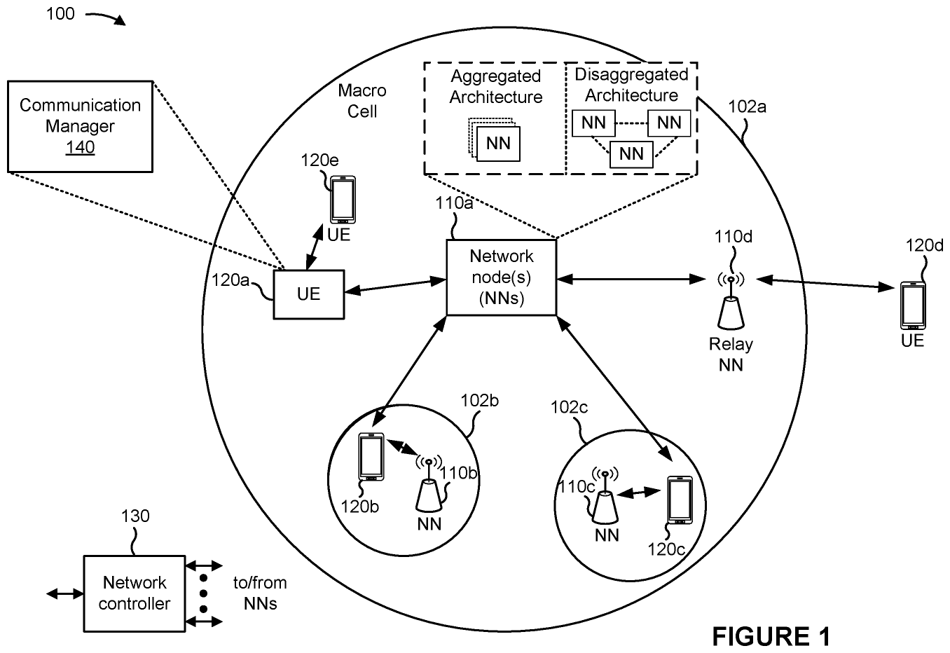

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, or a RAN node. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHZ), FR4 (52.6 GHz-114.25 GHz), and FR5 (114.25 GHz-300 GHz). Each of these higher frequency bands falls within the EHF band.

With the above examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, a WCD (for example, a UE) may include a communication manager 140. As described in more detail elsewhere herein, the communication manager 140 may perform, after selection of a first set of resources for a transmission of one or more TBs, one or more evaluations of availability of the first set of resources; and perform, in association with an unavailability of one or more resources of the first set of resources, one of: transmission of the one or more TBs via one or more available slots of the first set of resources; reselection of a second set of resources for transmission of the one or more TBs and transmission of the one or more TBs via the second set of resources; or reselection of a third set of resources for transmission of a first subset of the one or more TBs and transmission of a second subset of the one or more TBs on a subset of the first set of resources. Additionally or alternatively, the communication manager 140 may perform one or more other operations described herein.

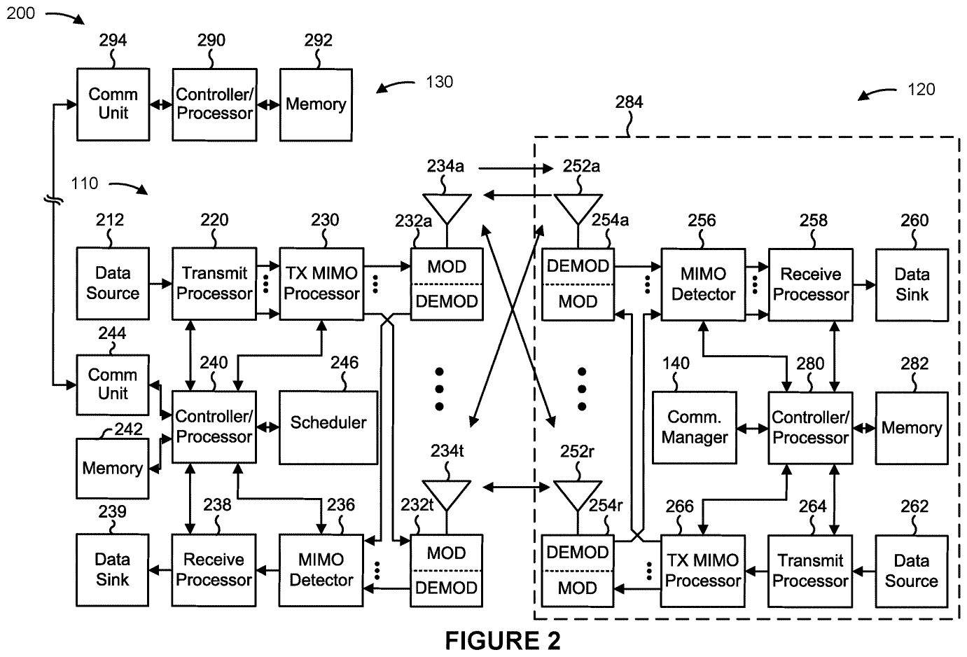

FIG. 2 is a diagram illustrating an example 200 of a network node in communication with a UE in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T ≥1). The UE 120 may be equipped with a set of antennas 252a through 252r, such as R antennas (R ≥1). The network node 110 of depicted in FIG. 2 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers or one or more processors. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

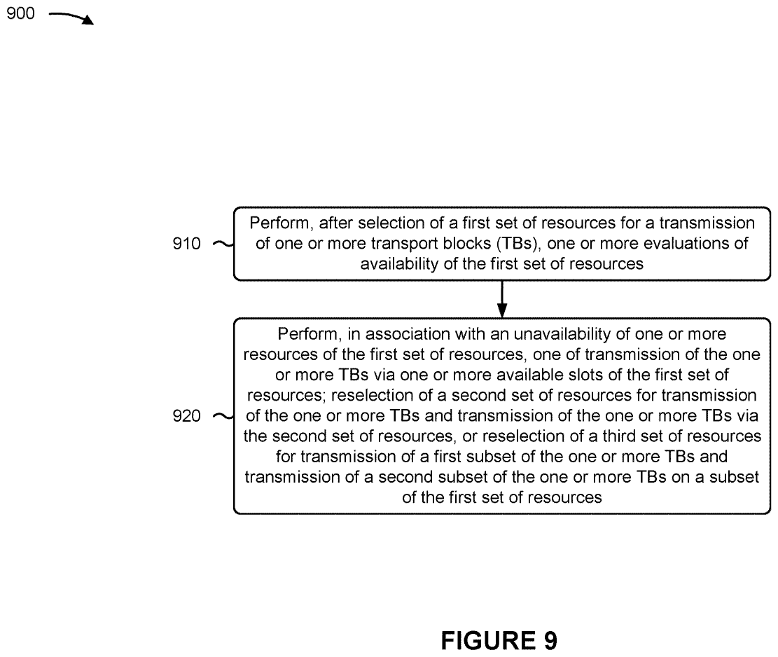

The controller/processor 240 of the network node 110, the controller/processor 280 of the UE 120, or any other component(s) of FIG. 2 may perform one or more techniques associated with selection and reselection of resources for transmission, as described in more detail elsewhere herein. For example, the controller/processor 240 of the network node 110, the controller/processor 280 of the UE 120, or any other component(s) of FIG. 2 may perform or direct operations of, for example, process 900 of FIG. 9, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 900 of FIG. 9, or other processes as described herein. In some examples, executing instructions may include running the instructions, converting the instructions, compiling the instructions, or interpreting the instructions, among other examples.

In some aspects, the WCD includes means for performing, after selection of a first set of resources for a transmission of one or more TBs, one or more evaluations of availability of the first set of resources; or means for performing, in association with an unavailability of one or more resources of the first set of resources, one of: transmission of the one or more TBs via one or more available slots of the first set of resources; reselection of a second set of resources for transmission of the one or more TBs and transmission of the one or more TBs via the second set of resources; or reselection of a third set of resources for transmission of a first subset of the one or more TBs and transmission of a second subset of the one or more TBs on a subset of the first set of resources. In some aspects, the means for the WCD to perform operations described herein may include, for example, one or more of communication manager 140, antenna 252, modem 254, MIMO detector 256, receive processor 258, transmit processor 264, TX MIMO processor 266, controller/processor 280, or memory 282.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, or one or more RUs).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

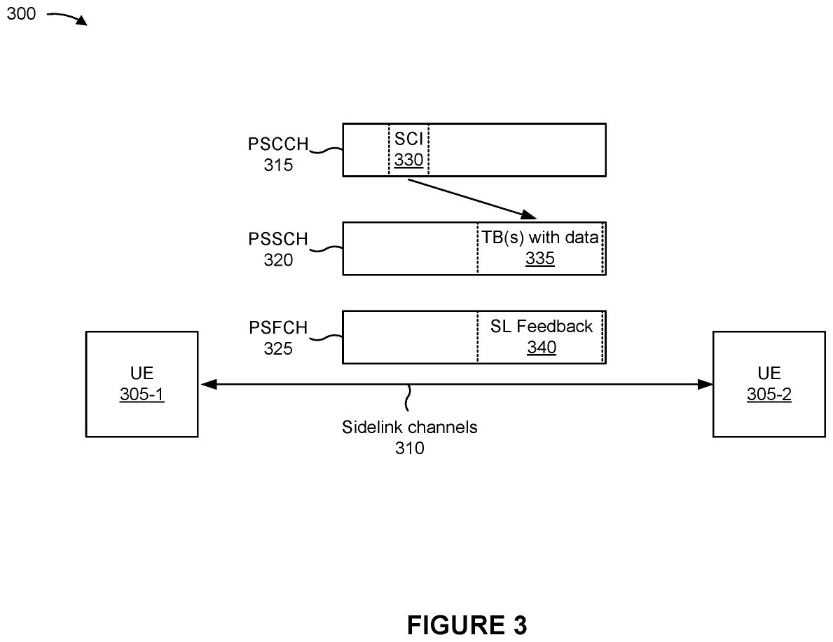

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (for example, which may include V2V communications, V2I communications, or V2P communications) or mesh networking. In some aspects, the UEs 305 (for example, UE 305-1 or UE 305-2) may correspond to one or more other UEs described elsewhere herein, such as UE 120. In some aspects, the one or more sidelink channels 310 may use a PC5 interface or may operate in a high frequency band (for example, the 5.9 GHz band).

Additionally or alternatively, the UEs 305 may synchronize timing of transmission time intervals (TTIs) (for example, frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, or a physical sidelink feedback channel (PSFCH) 325. The PSCCH 315 may be used to communicate control information, similar to a physical downlink control channel (PDCCH) or a physical uplink control channel (PUCCH) used for cellular communications with a network node 110 via an access link or an access channel. The PSSCH 320 may be used to communicate data, similar to a physical downlink shared channel (PDSCH) or a physical uplink shared channel (PUSCH) used for cellular communications with a network node 110 via an access link or an access channel. For example, the PSCCH 315 may carry sidelink control information (SCI) 330, which may indicate various control information used for sidelink communications, such as one or more resources (for example, time resources, frequency resources, or spatial resources) where a TB 335 may be carried on the PSSCH 320. The TB 335 may include data. The PSFCH 325 may be used to communicate sidelink feedback 340, such as hybrid automatic repeat request (HARQ) feedback (for example, acknowledgement or negative acknowledgement (ACK/NACK) information), transmit power control (TPC), or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (for example, time resources, frequency resources, or spatial resources) on the PSSCH 320, information for decoding sidelink communications on the PSSCH, a quality of service (QOS) priority value, a resource reservation period, a PSSCH DMRS pattern, an SCI format for the SCI-2, a beta offset for the SCI-2, a quantity of PSSCH DMRS ports, or an MCS. The SCI-2 may include information associated with data transmissions on the PSSCH 320, such as a HARQ process ID, a new data indicator (NDI), a source identifier, a destination identifier, or a channel state information (CSI) report trigger.

In some aspects, the one or more sidelink channels 310 may use resource pools. For example, a scheduling assignment (for example, included in SCI 330) may be transmitted in sub-channels using specific resource blocks (RBs) across time. In some aspects, data transmissions (for example, on the PSSCH 320) associated with a scheduling assignment may occupy adjacent RBs in the same subframe as the scheduling assignment (for example, using frequency division multiplexing). In some aspects, a scheduling assignment and associated data transmissions are not transmitted on adjacent RBs.

In some aspects, a UE 305 may operate using a sidelink transmission mode (for example, Mode 1) where resource selection or scheduling is performed by a network node 110 (for example, a base station, a CU, or a DU). For example, the UE 305 may receive a grant (for example, in downlink control information (DCI) or in a radio resource control (RRC) message, such as for configured grants) from the network node 110 (for example, directly or via one or more network nodes) for sidelink channel access or scheduling. In some aspects, a UE 305 may operate using a transmission mode (for example, Mode 2) where resource selection or scheduling is performed by the UE 305 (for example, rather than a network node 110). In some aspects, the UE 305 may perform resource selection or scheduling by sensing channel availability for transmissions. For example, the UE 305 may measure an RSSI parameter (for example, a sidelink-RSSI (S-RSSI) parameter) associated with various sidelink channels, may measure an RSRP parameter (for example, a PSSCH-RSRP parameter) associated with various sidelink channels, or may measure a RSRQ parameter (for example, a PSSCH-RSRQ parameter) associated with various sidelink channels, and may select a channel for transmission of a sidelink communication based at least in part on the measurement(s).

Additionally or alternatively, the UE 305 may perform resource selection or scheduling using SCI 330 received in the PSCCH 315, which may indicate occupied resources or channel parameters. Additionally or alternatively, the UE 305 may perform resource selection or scheduling by determining a channel busy ratio (CBR) associated with various sidelink channels, which may be used for rate control (for example, by indicating a maximum quantity of resource blocks that the UE 305 can use for a particular set of subframes).

In the transmission mode where resource selection or scheduling is performed by a UE 305, the UE 305 may generate sidelink grants, and may transmit the grants in SCI 330. A sidelink grant may indicate, for example, one or more parameters (for example, transmission parameters) to be used for an upcoming sidelink transmission, such as one or more resource blocks to be used for the upcoming sidelink transmission on the PSSCH 320 (for example, for TBs 335), one or more subframes to be used for the upcoming sidelink transmission, or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

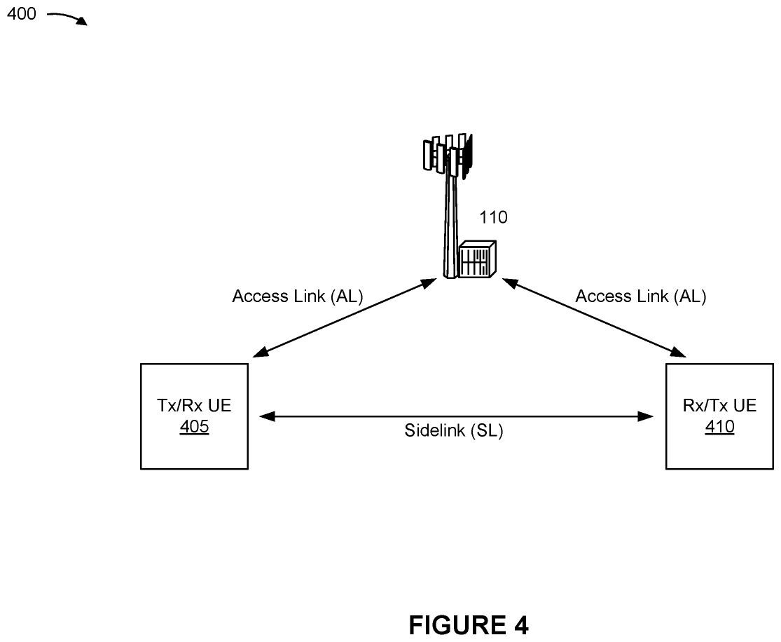

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a network node 110 may communicate with the Tx/Rx UE 405 (for example, directly or via one or more network nodes), such as via a first access link. Additionally or alternatively, in some sidelink modes, the network node 110 may communicate with the Rx/Tx UE 410 (for example, directly or via one or more network nodes), such as via a first access link. The Tx/Rx UE 405 or the Rx/Tx UE 410 may correspond to one or more UEs described elsewhere herein, such as the UE 120 of FIG. 1. Thus, a direct link between UEs 120 (for example, via a PC5 interface) may be referred to as a sidelink, and a direct link between a network node 110 and a UE 120 (for example, via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 4 is provided as an example. Other examples may differ from what is described with respect to FIG. 4.

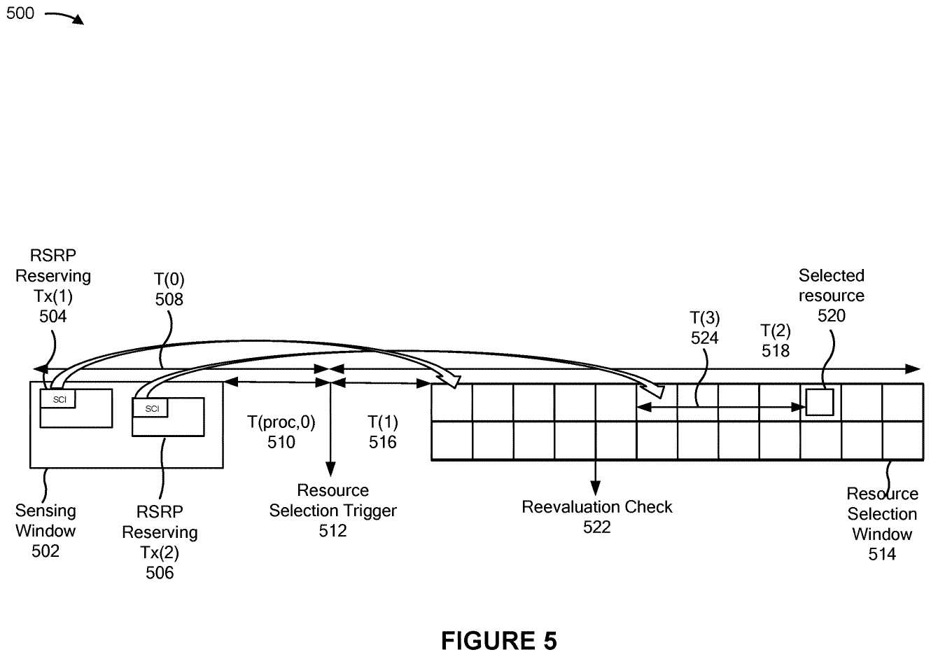

FIG. 5 is a diagram of an example 500 associated with selection of resources for transmission of a TB via a sidelink channel, in accordance with the present disclosure. As shown in FIG. 5, a WCD (for example, UE 120) may attempt to transmit to use resources of an unlicensed spectrum or other sidelink channel in which WCDs attempt to reserve resources from an available pool of resources.

As shown in FIG. 5, the WCD may sense occupancy or availability of resources in a sensing window 502. The WCD may monitor, within the sensing window, for reservations of resources, such as RSRP reserving transmission (Tx(1)) 504 or an RSRP reserving transmission (Tx(2)) 506. The WCD may process sensed signaling during T(proc, 0) 510 to identify reservations within the sensing window 502.

A resource selection trigger 512 may identify resources that are expected to be available for transmission of a communication. The resource selection trigger 512 may occur at time n, which may cause the WCD to examine the sensing window 502 to identify a set of candidate resources in a resource selection window 514 for transmission of the communication. The WCD may identify available resources based at least in part on measuring an RSRP of the RSRP reserving transmissions 504 or 506. For example, the WCD may identify a resource as available based at least in part on the RSRP of an associated RSRP reserving transmission failing to satisfy an RSRP threshold. Conversely, the WCD may identify a resource as unavailable (or occupied) based at least in part on the RSRP of an associated RSRP reserving transmission satisfying the RSRP threshold. A physical (PHY) layer of the WCD may measure the RSRPs and may provide an indication of available resources to a medium access control (MAC) layer of the WCD.

The resource selection window 514 may begin at a time T(1) 516 after the resource selection trigger 512 and may end at expiration of a packet delay budget associated with the communication. The time T(1) may be based at least in part on a capability of the WCD. The time T(1) 516 and a length of the resource selection window 514 may be defined as a time T(2) 518.

The WCD (for example, a MAC layer of the WCD) may select (for example, randomly) a resource for transmitting a TB associated with the resource selection trigger 512 and the packet delay budget. For example, the WCD may select selected resource 520 for transmission of the TB.

At a time T(3) before the selected resource 520, the WCD may perform a reevaluation check 522 to determine if the selected resource 520 is still available. For example, the WCD may check for new reservations collected between time of selection and T(3). If the reselection check fails (for example, the selected resource 520 is now unavailable), the WCD may perform a reselection of a new resource for transmission of the TB.

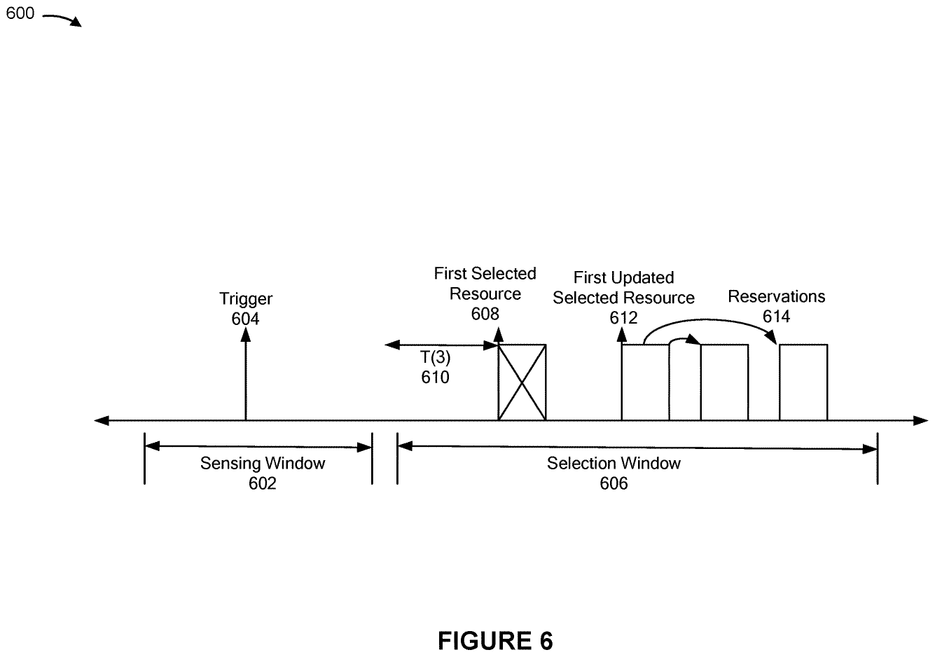

FIG. 6 is a diagram of an example 600 associated with selection of resources for transmission of a TB via a sidelink channel, in accordance with the present disclosure. As shown in FIG. 6, a WCD (for example, UE 120) may attempt to transmit to use resources of an unlicensed spectrum or other sidelink channel in which WCDs attempt to reserve resources from an available pool of resources.

As shown in FIG. 6, the WCD may monitor for reservations 614 during a sensing window 602. The WCD may receive a trigger 604 for transmission of a TB within the sensing window 602. The WCD may randomly select a resource for transmission of the TB within a selection window 606. For example, the WCD may select a first selected resource 608 for transmission of the TB.

At a time T(3) 610 before the first selected resource 608, the WCD may perform a reevaluation check to determine if the first selected resource 608 is still available. In case the first selected resource 608 is unavailable, the WCD may reselect a first updated selected resource 612. In such examples, the WCD should perform a new reevaluation at a time T(3) before the first updated selected resource 612.

Some networks may support multi-consecutive slots transmissions (MCSt) via a sidelink channel. The MCSt may improve throughput under channel access constraints. For example, the MCSt may allow the WCD to transmit over a maximum channel occupancy time (COT) duration (for example, 6 ms after Type 1 channel access via listen-before-talk (LBT) is cleared).

Some networks support an enhanced Mode 2 reservation where NI slots are selected for N2 TBs and N1>N2. In this way, a reservation may select more resources than are needed for transmission of a quantity of TBs. In some networks, preemption of a single-slot resource is enough to trigger re-selection.

In some aspects described herein, a WCD may be configured for reselection of resources for transmission of one or more TBs for a sidelink communication. Some aspects more specifically relate to using a configuration that indicates whether to transmit the one or more TBs in association with an unavailability of one or more resources of a first set of resources selected for transmission of the one or more TBs. In some aspects, the configuration may indicate whether to transmit the one or more TBs via available resources of the first set of resources (for example, remaining resources that are not unavailable) or to reselect a second set of resources for transmission of the one or more TBs.

In some aspects, the WCD may reselect the second set of resources based at least in part on the available resources being insufficient for transmitting the one or more TBs, a threshold percentage of the first set of resources being unavailable, or a quantity of contiguous slots failing to satisfy a threshold quantity, among other examples. In some aspects, the WCD may reselect the second set of resources to replace all of the first set of resources. In some aspects, the WCD may transmit a first subset of the one or more TBs via the available resources of the first set of resources and a second subset of the one or more TBs via the second set of resources.

In some aspects, the WCD may reselect the second set of resources based at least in part on an availability check, such as a reevaluation check failure or an LBT failure, among other examples. After a failure of the availability check, the WCD may evaluate whether the available resources of the first set of resources is sufficient to serve a target quantity of TBs (for example, N2<N1 TBs). If insufficient, re-selection is triggered. In some aspects, when an availability check fails, a quantity of available resources is updated to N1′=N1-x, and compared with N2. In some aspects, failure to satisfy an MCSt configuration may trigger re-selection (for example, based at least in part on a multi-slot resource containing gaps).

In some aspects, a reselection trigger may be based on a value N1′ of “surviving slots” that are still available from the first set of resources. For example, a reselection may be triggered based at least in part on N1′<N2. In another example, reselection may be triggered based at least in part on N1′<K% of N2 (for example, where K % may be pre-defined in a communication protocol or may be configured). In some aspects, N1′=0 is a valid case. In further example, reselection may be triggered based at least in part on N1′ containing fewer than L contiguous slots, where L may depends on N2 (for example, L=N2) or L depends on N1.

In some aspects, when reselection is triggered, the WCD may perform reselection of a quantity of resources that may be equal to, or less than, a quantity of resources of the first set of resources. For example, the WCD may reselect an entire multi-slot resource of the first set of resources (N1 slots). The selection of the first set of resources may be canceled and a selection of the second set of resources may be issued. In some aspects, the multi-slot resource may be already depleted and the WCD may have nothing to cancel. In some aspects, the WCD may reselect a quantity of resources associated with a deficit of resources needed to transmit the one or more TBs. For example, the selection of the first set of resources may be maintained, and a selection of the second set of resources may be issued for a quantity of slots of the first set of resources that are unavailable or a for a quantity of slots that is a difference between the quantity of available slots of the first set of resources (N1′) and a quantity of resources needed to transmit the one or more TBs (N2). In some examples, for a given value of N1′, re-selection is triggered, for a multi-slot resource of at least length N2-N1′ (for example K×(N2-N1′)).

In some aspects, for LBT failure (contributing to trigger reselection), the reselection may occur at a configured time. For example, the reselection may occur at the time where the transmission is intended to begin. This is the time at which an LBT failure would be recorded.

Alternatively, the reselection may occur at a time when the WCD discovers that is not possible to complete a countdown associated with the LBT in time for starting transmission at a boundary of the selected slot. The WCD may check if a remaining countdown can be completed before the transmission and, if not, update a quantity of remaining selected slots. If remaining resources are sufficient to transmit the one or more TBs, the WCD may shift a target for starting transmission to a next slot boundary, and eventually trigger re-selection if a threshold is met or the remaining resources are insufficient to transmit the one or more TBs. In some aspects, the reselection may occur at an occasion of any clear channel assessment (CCA) attempt (for example, every 9 microsecond) or with a periodicity (for example, every K CCA attempts, or every slot).

Particular aspects of the subject matter described in this disclosure can be implemented to realize one or more of the following potential advantages. In some examples, the described techniques can be used to use, when efficient, available resources of a set of resources to transmit all or a subset of TBs. In this way, the WCD may use the available resources, rather than wasting the available resources and reselecting a new, full set of resources. This may improve spectral efficiency and improve latency in an associated network by conserving network resources that may have otherwise been wasted or selected to be in the new, full set of resources.

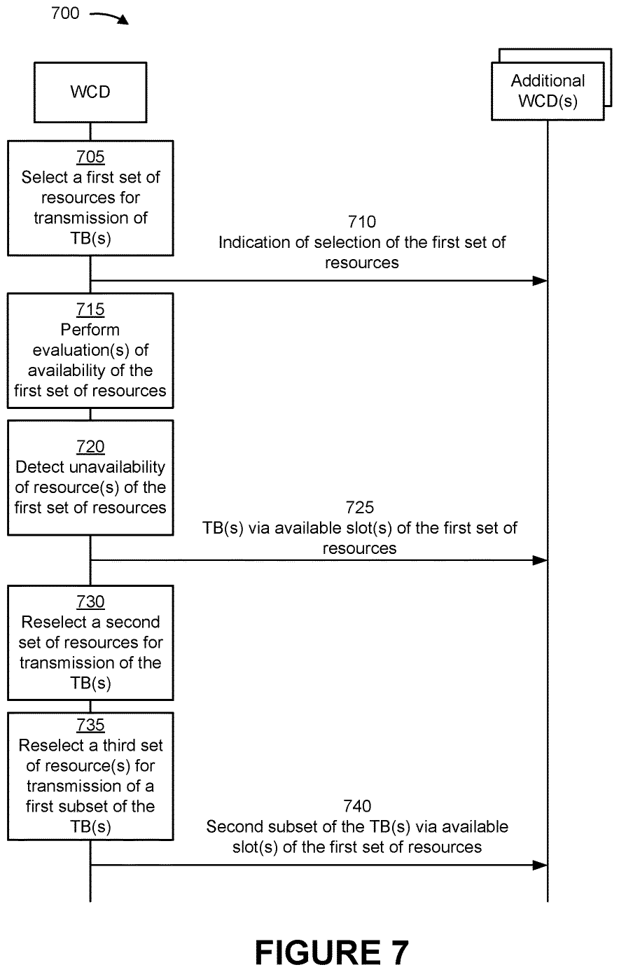

FIG. 7 is a diagram of an example 700 associated with selection and reselection of resources for transmission, in accordance with the present disclosure. As shown in FIG. 7, a WCD (for example, UE 120) may communicate with one or more additional WCDs in a sidelink channel of a wireless network (for example, wireless network 100). The WCD and the one or more additional WCDs may communicate using a sidelink communication protocol.

As shown in a first operation 705, the WCD may select a first set of resources for transmission of one or more TBs. In some aspects, the first set of resources comprises more resources than needed for transmitting one or more TBs to be transmitted via the first set of resources.

As shown in a second operation 710, the WCD may transmit an indication of selection of the first set of resources. For example, the WCD may transmit an RSRP reserving Tx message to reserve the first set of resources. In the alternative, the WCD may not transmit an indication of the selection to the one or more additional WCDs.

As shown in a third operation 715, the WCD may perform one or more evaluations of availability of the first set of resources. The WCD may perform the one or more evaluations after the selection of the first set of resources. In some aspects, the WCD may perform different evaluation checks for respective resources of the first set of resources. For example, the WCD may perform a first reevaluation check associated with a first resource of the one or more resources and perform a second reevaluation check associated with a second resource of the one or more resources. In such examples, detecting unavailability of the one or more resources includes detecting availability of the first resource based on the first reevaluation check and detecting availability of the second resource based on the second reevaluation check. In this way, availabilities of different resources of the first set of resources may be detected individually.

In some aspects, the one or more evaluations of availability of the one or more resources may include performing a reevaluation check associated with the one or more resources. In some aspects, the WCD may perform the reevaluation check at a periodic interval or based at least in part on a channel condition (for example, a channel busy ratio (CBR) measurement or an LBT failure).

In some aspects, the one or more evaluations of availability of the one or more resources may include performing an LBT check associated with the one or more resources. In some aspects, the WCD may detect failure of the LBT check, and detect the unavailability of the one or more resources at a start of a first-in-time resource of the one or more resources that are unavailable. In some aspects, the WCD may detect the unavailability of the one or more resources before the start of the first-in-time resource based on a successful LBT check being unable to be completed before the start of the first-in-time resource (for example, upon identifying a countdown of the LBT check being greater than an amount of time remaining before a start of a first-in-time resource). In some aspects, the WCD may detect the unavailability of the one or more resources after an unsuccessful CCA attempt. In some aspects, the WCD may detect the unavailability of the one or more resources at a periodic time after a determination that the successful LBT check is unable to be completed before the start of the first-in-time resource.

As shown in a fourth operation 720, the WCD may detect unavailability of one or more resources of the first set of resources.

Operations 725-740 discussed below may be performed as alternatives based at least in part on detecting unavailability of the one or more resources of the first set of resources. For example, a fifth operation 725 may be a first alternative, a sixth operation 730 may be a second alternative, and a seventh operation 735 and a ninth operation 740 may be a third alternative, among other examples. The WCD may be configured to only perform one of the alternatives, or may be configured with conditions for selecting one of the alternatives.

As shown in a fifth operation 725, the WCD may transmit the one or more TBs via one or more available slots (for example, available resources) of the first set of resources. In some aspects, the WCD may transmit the one or more TBs via the one or more available slots of the first set of resources based at least in part on the one or more available slots being sufficient to transmit the one or more TBs, a ratio of the quantity of available resources of the first set of resources to a quantity of resources needed for transmission of the one or more TBs satisfying a threshold ratio, or a quantity contiguous resources of the available resources of the first set of resources satisfying a threshold quantity of contiguous resources, among other examples. In some aspects, the basis for transmitting the one or more TBs via the one or more available resources may be indicated in a communication protocol or via a configuration associated with the sidelink channel.

As shown in a sixth operation 730, the WCD may reselect a second set of resources for transmission of the one or more TBs. In some aspects, the WCD may expect to transmit the one or more TBs via the second set of one or more resources. However, the WCD may perform one or more evaluations of availability of the second set of resources before transmission of the one or more TBs via the second set. If the second set of resources becomes unavailable, the WCD may reselect resources again.

In some aspects, the WCD may reselect the second set of resources for transmission of the one or more TBs based at least in part on the quantity of available resources of the first set of resources being insufficient for transmission of the one or more TBs, the ratio of the quantity of available resources of the first set of resources to the quantity of resources needed for transmission of the one or more TBs failing to satisfy the threshold ratio, or the quantity of contiguous resources of the available resources of the first set of resources failing to satisfy a threshold quantity of contiguous resources.

In some aspects, the WCD may cancel available resources of the first set of resources based at least in part on reselecting the second set of resources. In some aspects, the WCD may cancel the available resource of the first set of resources via transmission of an indication to cancel a reservation of the available resources.

As shown in a seventh operation 735, the WCD may reselect a third set of one or more resources for transmission of a first subset of the TBs. In some aspects, a quantity of resources of the third set of resources is based at least in part on a quantity of the one or more resources of the first set of resources that are unavailable, or a quantity of additional resources needed to transmit the one or more TBs based on the unavailability of the one or more resources that are unavailable.

In some aspects, the WCD may reselect the third set of resources for transmission of the one or more TBs based at least in part on the quantity of available resources of the first set of resources being insufficient for transmission of the one or more TBs, the ratio of the quantity of available resources of the first set of resources to the quantity of resources needed for transmission of the one or more TBs failing to satisfy the threshold ratio, or the quantity of contiguous resources of the available resources of the first set of resources failing to satisfy a threshold quantity of contiguous resources.

As shown in an eighth operation 740, the WCD may transmit a second subset of the one or more TBs via one or more available slots of the first set of resources. In some aspects, the WCD may expect to transmit the first subset of the one or more TBs via the third set of one or more resources. However, the WCD may perform one or more evaluations of availability of the third set of one or more resources before transmission of the first subset of the one or more TBs via the third set. If the third set of resources becomes unavailable, the WCD may reselect resources again.

Based at least in part on, after detecting unavailability of one or more resources of the first set of resources, allowing the WCD to use remaining resources of the first set of resources to transmit the one or more TBs or a subset of the one or more TBs, the WCD may use the available resources, rather than wasting the available resources and reselecting a new, full set of resources. This may improve spectral efficiency and improve latency in an associated network by conserving network resources that may have otherwise been wasted or selected to be in the new, full set of resources.

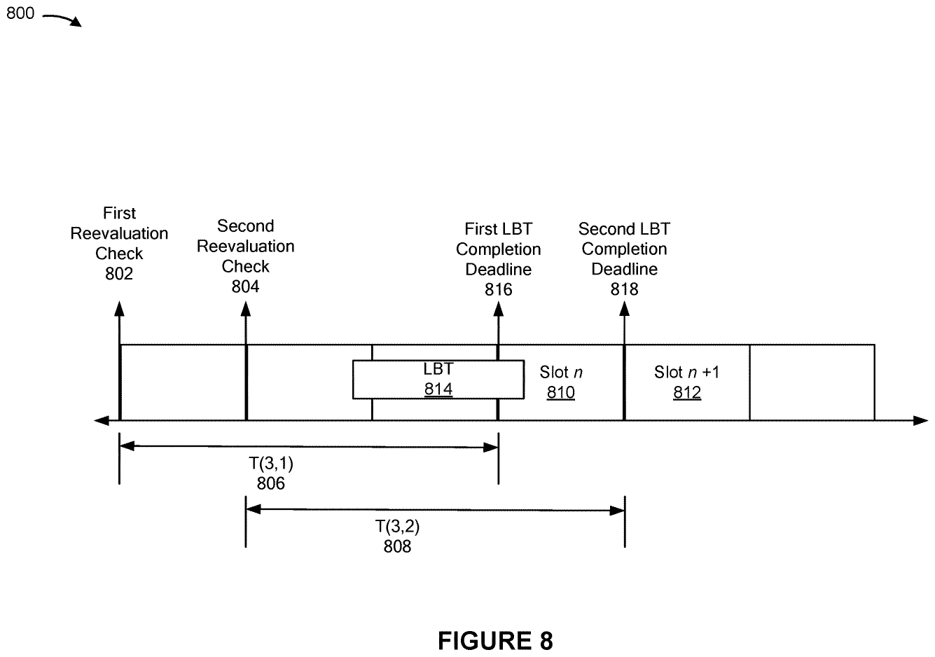

FIG. 8 is a diagram of an example 800 associated with selection and reselection of resources for transmission, in accordance with the present disclosure. As shown in FIG. 8, a WCD (for example, UE 120) may attempt to transmit to use resources of an unlicensed spectrum or other sidelink channel in which WCDs attempt to reserve resources from an available pool of resources. In some aspects, the WCD may have already selected a first set of resources for transmission of one or more TBs.

As shown in FIG. 8, the WCD may perform a first reevaluation check 802 and a second reevaluation check 804 associated with the first set of resources. For example, the WCD may check for new reservations collected between time of selection and T(3,1) 806 to perform the first reevaluation check 802. Similarly, the WCD may check for new reservations collected between time of selection and T(3,2) 808 to perform the second reevaluation check 804. The first reevaluation check 802 and T(3,1) 806 may be associated with a resource of the first set of resources at slot n 810. The second reevaluation check 804 and T(3,2) 808 may be associated with a resource of the first set of resources at slot n+1 812.

The WCD may perform an LBT check 814 before the slot n 810. The LBT check 814 may have a duration during which a subchannel must be clear for the WCD to transmit during a selected resource. Slot n 810 may be associated with a first LBT completion deadline 816, and slot n+1 812 may be associated with a second LBT completion deadline 818. If the LBT check 814 does not complete before the first LBT completion deadline 816, the resource at slot n 810 is not available for transmitting the one or more TBs. If the LBT check 814 does not complete before the second LBT completion deadline 818, the resource at slot n+1 812 is not available for transmitting the one or more TBs.

In the following examples, a quantity of selected resources (for example, slots) is 2 and a quantity of resources needed to transmit the one or more TBs is 1 (for example, 1 slot).

In a first example of performing evaluation checks, the first reevaluation check 802 may fail, the second reevaluation check 804 may pass, and slot n 810 may pass the LBT check 814. In such examples, the WCD may not transmit during slot n 810. However, the WCD may transmit during slot n+1 812 based at least in part on passing the second reevaluation check 804 and passing the LBT check 814 (for example, passing the first LBT completion deadline 816 may imply passing the second LBT completion deadline 818). In some aspects, the WCD may transmit the one or more TBs without reselection.

In a second example of performing evaluation checks, the first reevaluation check 802 may fail and the second reevaluation check 804 may fail. In such examples, the WCD may not transmit during slot n 810 or during the slot n+1 812. The WCD may therefore trigger reselection.

In a third example of performing evaluation checks, the first reevaluation check 802 may pass, the second reevaluation check 804 may fail, and slot n 810 may fail the LBT check 814. In such examples, the WCD may not transmit during slot n 810 or during the slot n+1 812 based at least in part on both slots failing an evaluation of availability. The WCD may therefore trigger reselection.

In a fourth example of performing evaluation checks, the first reevaluation check 802 may pass, the second reevaluation check 804 may pass, slot n 810 may fail the LBT check 814, and slot n+1 812 may pass the LBT check 814. In such examples, the WCD may not transmit during slot n 810. However, the WCD may transmit during slot n+1 812 based at least in part on passing the second reevaluation check 804 and passing the LBT check 814. In some aspects, the WCD may transmit the one or more TBs without reselection.

In a fifth example of performing evaluation checks, the first reevaluation check 802 may pass, the second reevaluation check 804 may pass, slot n 810 may fail the LBT check 814, and slot n+1 812 may fail the LBT check 814. In such examples, the WCD may not transmit during slot n 810 or during the slot n+1 812 based at least in part on both slots failing an evaluation of availability. The WCD may therefore trigger reselection.

FIG. 9 is a diagram illustrating an example process 900 performed, for example, by a WCD, in accordance with the present disclosure. Example process 900 is an example where the WCD (for example, UE 120) performs operations associated with selection and reselection of resources for transmission.

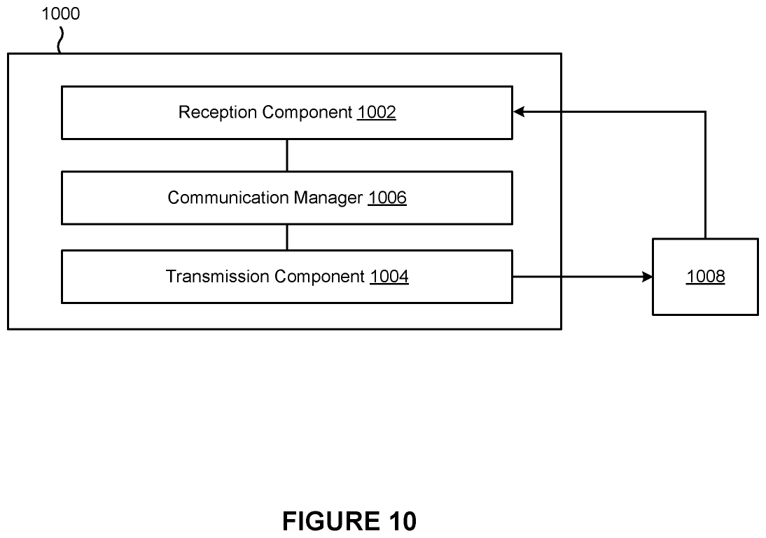

As shown in FIG. 9, in some aspects, process 900 may include performing, after selection of a first set of resources for a transmission of one or more TBs, one or more evaluations of availability of the first set of resources (block 910). For example, the WCD (for example, using communication manager 1006, depicted in FIG. 10) may perform, after selection of a first set of resources for a transmission of one or more TBs, one or more evaluations of availability of the first set of resources, as described above.

As further shown in FIG. 9, in some aspects, process 900 may include performing, in association with an unavailability of one or more resources of the first set of resources, one of: transmission of the one or more TBs via one or more available slots of the first set of resources; reselection of a second set of resources for transmission of the one or more TBs and transmission of the one or more TBs via the second set of resources; or reselection of a third set of resources for transmission of a first subset of the one or more TBs and transmission of a second subset of the one or more TBs on a subset of the first set of resources (block 920). For example, the WCD (for example, using communication manager 1006, depicted in FIG. 10) may perform, in association with an unavailability of one or more resources of the first set of resources, one of: transmission of the one or more TBs via one or more available slots of the first set of resources; reselection of a second set of resources for transmission of the one or more TBs and transmission of the one or more TBs via the second set of resources; or reselection of a third set of resources for transmission of a first subset of the one or more TBs and transmission of a second subset of the one or more TBs on a subset of the first set of resources, as described above.

Process 900 may include additional aspects, such as any single aspect or any combination of aspects described below or in connection with one or more other processes described elsewhere herein.

In a first aspect, process 900 includes selecting the first set of resources wherein the first set of resources comprises more resources than needed for transmitting the one or more TBs.

In a second aspect, alone or in combination with the first aspect, performing the one or more evaluations of availability of the one or more resources comprises one or more of performing a reevaluation check associated with the one or more resources, or performing an LBT check associated with the one or more resources.

In a third aspect, alone or in combination with one or more of the first and second aspects, performing the reevaluation check associated with the one or more resources comprises one or more of performing a first reevaluation check associated with a first resource of the one or more resources, or performing a second reevaluation check associated with a second resource of the one or more resources, wherein detecting unavailability of the one or more resources comprises detecting availability of the first resource based on the first reevaluation check and detecting availability of the second resource based on the second reevaluation check.

In a fourth aspect, alone or in combination with one or more of the first through third aspects, performing the reevaluation check associated with the one or more resources comprises one or more of performing the reevaluation check at a periodic interval, or performing the reevaluation check based at least in part on a channel condition.

In a fifth aspect, alone or in combination with one or more of the first through fourth aspects, performing the LBT check associated with the one or more resources comprises performing a first LBT check associated with a first resource of the one or more resources, and performing a second LBT check associated with a second resource of the one or more resources, wherein detecting unavailability of the one or more resources comprises detecting availability of the first resource based on the first LBT check and detecting availability of the second resource based on the second LBT check.

In a sixth aspect, alone or in combination with one or more of the first through fifth aspects, performing the LBT check associated with the one or more resources comprises detecting failure of the LBT check, and the unavailability of the one or more resources at a start of a first-in-time resource of the one or more resources that are unavailable, before the start of the first-in-time resource based on a successful LBT check being unable to be completed before the start of the first-in-time resource, after an unsuccessful CCA attempt, or at a periodic time after a determination that the successful LBT check is unable to be completed before the start of the first-in-time resource.

In a seventh aspect, alone or in combination with one or more of the first through sixth aspects, transmission of the one or more TBs via the one or more available slots of the first set of resources is based on one or more of the one or more available slots being sufficient to transmit the one or more TBs, a ratio of the quantity of available resources of the first set of resources to a quantity of resources needed for transmission of the one or more TBs satisfying a threshold ratio, or a quantity contiguous resources of the available resources of the first set of resources satisfying a threshold quantity of contiguous resources.

In an eighth aspect, alone or in combination with one or more of the first through seventh aspects, reselection of the second set of resources or reselection of the third set of resources is based on one or more of a quantity of available resources of the first set of resources being insufficient for transmission of the one or more TBs, a ratio of the quantity of available resources of the first set of resources to a quantity of resources needed for transmission of the one or more TBs failing to satisfy a threshold ratio, or the quantity of contiguous resources of the available resources of the first set of resources failing to satisfy a threshold quantity of contiguous resources.

In a ninth aspect, alone or in combination with one or more of the first through eighth aspects, reselection of the second set of resources comprises canceling available resources of the first set of resources.

In a tenth aspect, alone or in combination with one or more of the first through ninth aspects, a quantity of resources of the second set of resources or the third set of resources is based on a quantity of the one or more resources of the first set of resources that are unavailable, or a quantity of additional resources needed to transmit the one or more TBs based on the unavailability of the one or more resources that are unavailable.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a diagram of an example apparatus 1000 for wireless communication, in accordance with the present disclosure. The apparatus 1000 may be a WCD, or a WCD may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 7-8. Additionally or alternatively, the apparatus 1000 may be configured to perform one or more processes described herein, such as process 900 of FIG. 9. In some aspects, the apparatus 1000 or one or more components shown in FIG. 10 may include one or more components of the WCD described in connection with FIG. 2. Additionally or alternatively, one or more components shown in FIG. 10 may be implemented within one or more components described in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the WCD described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the WCD described in connection with FIG. 2. In some aspects, the transmission component 1004 may be co-located with the reception component 1002 in a transceiver.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally or alternatively, the communication manager 1006 may generate or provide control information to the reception component 1002 or the transmission component 1004 to control reception or transmission of communications.

The communication manager 1006 may perform, after selection of a first set of resources for a transmission of one or more TBs, one or more evaluations of availability of the first set of resources. The communication manager 1006 may selectively perform, in association with an unavailability of one or more resources of the first set of resources, one of transmission of the one or more TBs via one or more available slots of the first set of resources; reselection of a second set of resources for transmission of the one or more TBs and transmission of the one or more TBs via the second set of resources; or reselection of a third set of resources for transmission of a first subset of the one or more TBs and transmission of a second subset of the one or more TBs on a subset of the first set of resources.

The communication manager 1006 may select the first set of resources wherein the first set of resources comprises more resources than needed for transmitting the one or more TBs.

The quantity and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by a wireless communication device (WCD), comprising: performing, after selection of a first set of resources for a transmission of one or more transport blocks (TBs), one or more evaluations of availability of the first set of resources; and performing, in association with an unavailability of one or more resources of the first set of resources, one of: transmission of the one or more TBs via one or more available slots of the first set of resources; reselection of a second set of resources for transmission of the one or more TBs and transmission of the one or more TBs via the second set of resources; or reselection of a third set of resources for transmission of a first subset of the one or more TBs and transmission of a second subset of the one or more TBs on a subset of the first set of resources.
Aspect 2: The method of Aspect 1, further comprising selecting the first set of resources wherein the first set of resources comprises more resources than needed for transmitting the one or more TBs.
Aspect 3: The method of any of Aspects 1-2, wherein performing the one or more evaluations of availability of the one or more resources comprises one or more of: performing a reevaluation check associated with the one or more resources, or performing a listen-before-talk (LBT) check associated with the one or more resources.
Aspect 4: The method of Aspect 3, wherein performing the reevaluation check associated with the one or more resources comprises one or more of: performing a first reevaluation check associated with a first resource of the one or more resources; or performing a second reevaluation check associated with a second resource of the one or more resources, wherein detecting unavailability of the one or more resources comprises detecting availability of the first resource in association with the first reevaluation check and detecting availability of the second resource in association with the second reevaluation check.
Aspect 5: The method of Aspect 3, wherein performing the reevaluation check associated with the one or more resources comprises one or more of: performing the reevaluation check at a periodic interval, or performing the reevaluation check based at least in part on a channel condition.
Aspect 6: The method of Aspect 3, wherein performing the LBT check associated with the one or more resources comprises: performing a first LBT check associated with a first resource of the one or more resources; and performing a second LBT check associated with a second resource of the one or more resources, wherein detecting unavailability of the one or more resources comprises detecting availability of the first resource in association with the first LBT check and detecting availability of the second resource in association with the second LBT check.
Aspect 7: The method of Aspect 3, wherein performing the LBT check associated with the one or more resources comprises detecting failure of the LBT check, and the unavailability of the one or more resources: at a start of a first-in-time resource of the one or more resources that are unavailable, before the start of the first-in-time resource in association with a successful listen-before-talk (LBT) check being unable to be completed before the start of the first-in-time resource, after an unsuccessful clear channel assessment (CCA) attempt, or at a periodic time after a determination that the successful LBT check is unable to be completed before the start of the first-in-time resource.
Aspect 8: The method of any of Aspects 1-7, wherein transmission of the one or more TBs via the one or more available slots of the first set of resources is associated with one or more of: the one or more available slots being sufficient to transmit the one or more TBs, a ratio of the quantity of available resources of the first set of resources to a quantity of resources needed for transmission of the one or more TBs satisfying a threshold ratio, or a quantity contiguous resources of the available resources of the first set of resources satisfying a threshold quantity of contiguous resources.
Aspect 9: The method of any of Aspects 1-8, wherein reselection of the second set of resources or reselection of the third set of resources is associated with one or more of: a quantity of available resources of the first set of resources being insufficient for transmission of the one or more TBs, a ratio of the quantity of available resources of the first set of resources to a quantity of resources needed for transmission of the one or more TBs failing to satisfy a threshold ratio, or the quantity of contiguous resources of the available resources of the first set of resources failing to satisfy a threshold quantity of contiguous resources.
Aspect 10: The method of any of Aspects 1-9, wherein reselection of the second set of resources comprises canceling available resources of the first set of resources.
Aspect 11: The method of any of Aspects 1-10, wherein a quantity of resources of the second set of resources or the third set of resources is associated with: a quantity of the one or more resources of the first set of resources that are unavailable, or a quantity of additional resources needed to transmit the one or more TBs associated with the unavailability of the one or more resources that are unavailable.
Aspect 12: An apparatus for wireless communication at a device, comprising a processor; memory coupled with the processor; and instructions stored in the memory and executable by the processor to cause the apparatus to perform the method of one or more of Aspects 1-11.
Aspect 13: A device for wireless communication, comprising a memory and one or more processors coupled to the memory, the one or more processors configured to perform the method of one or more of Aspects 1-11.
Aspect 14: An apparatus for wireless communication, comprising at least one means for performing the method of one or more of Aspects 1-11.
Aspect 15: A non-transitory computer-readable medium storing code for wireless communication, the code comprising instructions executable by a processor to perform the method of one or more of Aspects 1-11.
Aspect 16: A non-transitory computer-readable medium storing a set of instructions for wireless communication, the set of instructions comprising one or more instructions that, when executed by one or more processors of a device, cause the device to perform the method of one or more of Aspects 1-11.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

1. A wireless communication device (WCD) for wireless communication, comprising:
a processing system that includes one or more processors and one or more memories coupled with the one or more processors, the processing system configured to cause the WCD to:
perform, after selection of a first set of resources for a transmission of one or more transport blocks (TBs), one or more evaluations of availability of the first set of resources; and
perform, in association with an unavailability of one or more resources of the first set of resources, one of:
transmission of the one or more TBs via one or more available slots of the first set of resources;
reselection of a second set of resources for transmission of the one or more TBs and transmission of the one or more TBs via the second set of resources; or
reselection of a third set of resources for transmission of a first subset of the one or more TBs and transmission of a second subset of the one or more TBs on a subset of the first set of resources.

2. The WCD of claim 1, wherein the processing system is further configured to cause the WCD to select the first set of resources, and wherein the first set of resources comprises more resources than needed for transmission of the one or more TBs.

3. The WCD of claim 1, wherein the processing system, to cause the WCD to perform the one or more evaluations of availability of the one or more resources, is configured to cause the WCD to:
perform a reevaluation check associated with the one or more resources, or
perform a listen-before-talk (LBT) check associated with the one or more resources.

4. The WCD of claim 3, wherein the processing system, to cause the WCD to perform the reevaluation check associated with the one or more resources, is configured to cause the WCD to:
perform a first reevaluation check associated with a first resource of the one or more resources; or
perform a second reevaluation check associated with a second resource of the one or more resources, and
wherein the processing system is further configured to cause the WCD to:
detect availability of the first resource in association with the first reevaluation check; and
detect availability of the second resource in association with the second reevaluation check.

5. The WCD of claim 3, wherein the processing system, to cause the WCD to perform the reevaluation check associated with the one or more resources, is configured to cause the WCD to:
perform the reevaluation check at a periodic interval, or
perform the reevaluation check based at least in part on a channel condition.

6. The WCD of claim 3, wherein the processing system, to cause the WCD to perform the LBT check associated with the one or more resources, is configured to cause the WCD to:
perform a first LBT check associated with a first resource of the one or more resources; and
perform a second LBT check associated with a second resource of the one or more resources,
wherein the processing system, to cause the WCD to detect unavailability of the one or more resources, is configured to cause the WCD to:
detect availability of the first resource in association with the first LBT check; and
detect availability of the second resource in association with the second LBT check.

7. The WCD of claim 3, wherein the processing system, to cause the WCD to perform the LBT check associated with the one or more resources, is configured to cause the WCD to detect failure of the LBT check, and the unavailability of the one or more resources:
at a start of a first-in-time resource of the one or more resources that are unavailable, before the start of the first-in-time resource in association with a successful listen-before-talk (LBT) check being unable to be completed before the start of the first-in-time resource, after an unsuccessful clear channel assessment (CCA) attempt, or
at a periodic time after a determination that the successful LBT check is unable to be completed before the start of the first-in-time resource.

8. The WCD of claim 1, wherein transmission of the one or more TBs via the one or more available slots of the first set of resources is associated with one or more of:
the one or more available slots being sufficient to transmit the one or more TBs,
a ratio of a quantity of available resources of the first set of resources to a quantity of resources needed for transmission of the one or more TBs satisfying a threshold ratio, or
a quantity contiguous resources of the available resources of the first set of resources satisfying a threshold quantity of contiguous resources.

9. The WCD of claim 1, wherein reselection of the second set of resources or reselection of the third set of resources is associated with one or more of:
a quantity of available resources of the first set of resources being insufficient for transmission of the one or more TBs,
a ratio of the quantity of available resources of the first set of resources to a quantity of resources needed for transmission of the one or more TBs failing to satisfy a threshold ratio, or
the quantity of contiguous resources of the available resources of the first set of resources failing to satisfy a threshold quantity of contiguous resources.

10. The WCD of claim 1, wherein the processing system, to cause the WCD to reselect of the second set of resources, is configured to cause the WCD to cancel available resources of the first set of resources.

11. The WCD of claim 1, wherein a quantity of resources of the second set of resources or the third set of resources is associated with:
a quantity of the one or more resources of the first set of resources that are unavailable, or a quantity of additional resources needed to transmit the one or more TBs associated with the unavailability of the one or more resources that are unavailable.

12. A method of wireless communication by a wireless communication device (W CD), comprising:
performing, after selection of a first set of resources for a transmission of one or more transport blocks (TBs), one or more evaluations of availability of the first set of resources; and performing, in association with an unavailability of one or more resources of the first set of resources, one of:
transmission of the one or more TBs via one or more available slots of the first set of resources;
reselection of a second set of resources for transmission of the one or more TBs and transmission of the one or more TBs via the second set of resources; or
reselection of a third set of resources for transmission of a first subset of the one or more TBs and transmission of a second subset of the one or more TBs on a subset of the first set of resources.

13. The method of claim 12, further comprising selecting the first set of resources, wherein the first set of resources comprises more resources than needed for transmitting the one or more TBs.

14. The method of claim 12, wherein performing the one or more evaluations of availability of the one or more resources comprises one or more of:
performing a reevaluation check associated with the one or more resources, or performing a listen-before-talk (LBT) check associated with the one or more resources.

15. The method of claim 14, wherein performing the reevaluation check associated with the one or more resources comprises one or more of:
performing a first reevaluation check associated with a first resource of the one or more resources; or
performing a second reevaluation check associated with a second resource of the one or more resources, wherein detecting unavailability of the one or more resources comprises detecting availability of the first resource in association with the first reevaluation check and detecting availability of the second resource in association with the second reevaluation check.

16. The method of claim 14, wherein performing the reevaluation check associated with the one or more resources comprises one or more of:
performing the reevaluation check at a periodic interval, or
performing the reevaluation check based at least in part on a channel condition.

17. The method of claim 14, wherein performing the LBT check associated with the one or more resources comprises:
performing a first LBT check associated with a first resource of the one or more resources; and
performing a second LBT check associated with a second resource of the one or more resources,
wherein detecting unavailability of the one or more resources comprises detecting availability of the first resource in association with the first LBT check and detecting availability of the second resource in association with the second LBT check.

18. The method of claim 14, wherein performing the LBT check associated with the one or more resources comprises detecting failure of the LBT check, and the unavailability of the one or more resources:
at a start of a first-in-time resource of the one or more resources that are unavailable, before the start of the first-in-time resource in association with a successful listen-before-talk (LBT) check being unable to be completed before the start of the first-in-time resource, after an unsuccessful clear channel assessment (CCA) attempt, or
at a periodic time after a determination that the successful LBT check is unable to be completed before the start of the first-in-time resource.

19. The method of claim 12, wherein transmission of the one or more TBs via the one or more available slots of the first set of resources is associated with one or more of:
the one or more available slots being sufficient to transmit the one or more TBs,
a ratio of a quantity of available resources of the first set of resources to a quantity of resources needed for transmission of the one or more TBs satisfying a threshold ratio, or
a quantity contiguous resources of the available resources of the first set of resources satisfying a threshold quantity of contiguous resources.

20. The method of claim 12, wherein reselection of the second set of resources or reselection of the third set of resources is associated with one or more of:
a quantity of available resources of the first set of resources being insufficient for transmission of the one or more TBs,
a ratio of the quantity of available resources of the first set of resources to a quantity of resources needed for transmission of the one or more TBs failing to satisfy a threshold ratio, or
the quantity of contiguous resources of the available resources of the first set of resources failing to satisfy a threshold quantity of contiguous resources.

21-30. (canceled)
